(19) United States
(12) Patent Application Publication
(10) Pub. No.: US 2026/0268919 A1
(43) Pub. Date: Sep. 10, 2026

(54) CONTEXT-AWARE REAL-TIME SPEAKER PRIORITIZATION USING ACOUSTIC AND LINGUISTIC EMBEDDINGS

(71) Applicant: Intel Corporation, Santa Clara, CA (US)

(72) Inventors: Yaaqov Guetta, Netanya (IL); Yaron Klein, Rosh Haayin (IL); Ilil Blum Shem-Tov, Kiryat Tivon (IL); Coral Kuta, Rosh HaAyin (IL)

(73) Assignee: Intel Corporation, Santa Clara, CA (US)

(21) Appl. No.: 19/461,443

(22) Filed: Jan. 27, 2026

(51) Int. Cl. G10L 21/0208; G10L 15/26; G10L 17/00

(52) U.S. Cl. CPC G10L 21/0208; G10L 15/26; G10L 17/00; G10L 2021/02087

(57) ABSTRACT

Systems and methods are provided for context-aware, real-time speaker prioritization and enhancement. A speech encoder is provided that enables real-time prioritization of the speaker who is contextually most important rather than merely the loudest. The system uses a single-pass architecture and integrates comprehensive semantic analysis with acoustic speaker identification so that speaker focus is directed based on contextual importance rather than acoustic prominence. Comprehensive semantic analyses can include content-relevance assessment, vocabulary domain detection, identification of speaker roles, evaluation of dialogue context, and tracking of conversational continuity. The system simultaneously generates a transcript of the prioritized speech. A self-calibration loop monitors enhanced audio and transcript quality indicators and automatically adjusts fusion weights and enhancement parameters over time, enabling robust performance across changing acoustic conditions and conversation styles. The approach yields low-latency, profile-configurable speaker prioritization that can be used for conferencing and collaboration, education, accessibility use cases, and high-noise personal communications.

### TECHNICAL FIELD

This disclosure relates generally to real-time speaker prioritization, and in particular to context-aware real-time speaker prioritization using combined acoustic and linguistic embeddings from a speech-to-text encoder.

### BACKGROUND

Real-time communication systems struggle in multi-speaker settings when multiple people speak simultaneously. This is because conventional pipelines treat source separation, speaker identification, and speech recognition as independent, sequential stages. The resulting redundancy and latency scale poorly with speaker count. For example, overlapping speech causes diarization and enhancement failures, and audio processing typically ignores conversational context, so importance is assigned to whoever is loudest rather than to the most contextually relevant speaker.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram illustrating an example architecture for a context-aware speaker prioritization system 100, according to various embodiments.

FIG. 2 is a block diagram illustrating a processing sequence for a context-aware speaker prioritization system, according to various embodiments.

FIGS. 3A-3C are block diagrams, illustrating the multi-speaker context fusion process for a context-aware speaker prioritization system, according to various embodiments.

FIG. 4 is a block diagram illustrating an encoder-agnostic adapter for a context-aware speaker prioritization system, according to various embodiments.

FIG. 5 is a block diagram illustrating a self-calibration feedback loop for a context-aware speaker prioritization system, according to various embodiments.

FIG. 6 is a block diagram illustrating use case deployment scenarios for a context-aware speaker prioritization system, according to various embodiments.

FIG. 7 illustrates a method that can be used for context-aware speaker prioritization, in accordance with various embodiments.

FIG. 8 is a block diagram of a deep learning system that can be used for context-aware speaker prioritization, in accordance with various embodiments.

FIG. 9 is a block diagram of an example computing device, in accordance with various embodiments.

### DESCRIPTION

### Overview

Systems and methods are provided for a context-aware real-time multi-speaker speech encoding that concurrently determines both what is being spoken and who is speaking. In particular, a speech encoder is provided that enables real-time prioritization of the speaker who is contextually most important rather than merely the loudest. The system integrates comprehensive semantic analysis with acoustic speaker identification so that speaker focus is directed based on contextual importance rather than acoustic prominence. In some examples, comprehensive semantic analyses can include content-relevance assessment, vocabulary domain detection, identification of speaker roles, evaluation of dialogue context, and tracking of conversational continuity. By way of example, in a gym environment, the system prioritizes meeting relevant business vocabulary over unrelated fitness chatter, irrespective of the respective volume levels, thereby demonstrating contextual understanding that eliminates the computational waste and latency associated with traditional sequential processing.

There are several conventional approaches to multi-speaker speech encoding. One approach is an acoustic processing approach (e.g., beam-forming, noise suppression), which relies on energy levels and spatial cues. However, the acoustic processing approach fails when there are overlapping speakers of similar volume. Another approach includes target-speaker enhancement systems (e.g., VoiceFilter, SpeakerBeam) which use pre-enrolled voice samples and are unable to adapt to dynamic conversational roles. A third type of approach includes context-aware techniques that combine speech recognition and enhancement but use separate models in sequence, resulting in latency and preventing real-time adaptation to changing conversational importance.

According to various implementations, systems and methods are presented herein for a unified streaming architecture that processes each audio frame once through a single speech-to-text encoder which concurrently emits two synchronized outputs: (1) incremental linguistic tokens for transcription and semantic analysis, and (2) acoustic speaker embeddings for identity and activity analysis. An encoder-agnostic adapter layer standardizes heterogeneous encoder outputs (feature selection, normalization to canonical ranges, temporal rate matching, and common data structures) so downstream components operate uniformly regardless of the encoder model. In various examples, the encoder can be Whisper, Conformer, wav2vec2/HuBERT, or any commercial automatic speech recognition (ASR) system. The consolidation of semantic and contextual analysis eliminates cascaded ASR enhancement passes, preserves tight token and embedding synchrony, and enables low-latency decision making on a per-frame basis.

According to various implementations, the encoding systems and methods include multiple stages. A context analysis stage evaluates the token stream for multi-dimensional semantic cues, including, for example, content relevance to meeting/domain vocabulary, keyword significance, turn taking and continuity, and role indicators (e.g., lecturer, chairperson, participant). Meanwhile, the speaker identifier stage forms scalable clusters, computes similarity to evolving voice profiles, detects activity and continuity, and provides confidence measures. A context fusion engine combines the “what” and the “who” into a priority score per active speaker using adaptive weights (e.g., α for acoustic confidence, β for semantic relevance, γ for role/authority, δ for keyword boost). Stability controls (hysteresis/smoothing) resist rapid toggling among near-tied speakers, and an adaptive weighting loop tunes α, β, γ, δ to the operating context (e.g., higher β in high-noise gyms).

In various implementations, a focus selector stage converts the ranked priorities into a concrete selection policy (e.g., “top 1 only” in a gym profile; “allow brief handoffs” in a hybrid meeting), and the enhancement engine generates a spectral emphasis profile that amplifies the selected primary speaker while preserving natural ambience. The enhancement engine operates on the original buffered audio frame, ensuring fidelity, while the adapter also routes clean transcript tokens directly to the system output for output text including, for example, speaker-tagged captions. According to various examples, the system achieves frame-synchronous enhancement and transcription without extra buffering or second-pass processing.

According to some implementations, quality is maintained by a self-calibration feedback loop that monitors enhanced audio and generated transcript to determine quantitative indicators: speaker switch stability, audio clarity (SNR/SIR), semantic coherence (language model perplexity), content relevance, artifact detection, and word error proxies. In some examples, bounded updates adjust fusion weights and enhancement masks, and safeguards pause adaptation during double talk, enable rollback if changes degrade quality, and provide an emergency bypass if thresholds signal critical instability. In some examples, the quality controls prevent oscillation, maintain intelligibility, and keep priority decisions aligned with conversational context over extended sessions.

In some implementations, the systems and methods provided herein support deployment configuration profiles that initialize and constrain behavior for distinct environments. For example, a business profile balances role hierarchy with content relevance for structured meetings and respects formal handoffs. In another example, a high-noise gym profile raises β (semantic relevance) and reduces α (acoustic confidence) so meeting-related speech is emphasized over ambient chatter and rhythmic machine noise. In various examples, profiles can be selected at session start and refined by the calibration manager, enabling immediate fit-for-purpose behavior that can also adapt as conditions change.

In various examples, the system can leverage a platform that includes multiple specialized compute engines for real-time operation at low power. For example, the speech encoder can execute on a neural processing unit (NPU), the context analysis can execute on CPU vector units, mask synthesis can execute on an integrated graphics unit, and audio reconstruction can execute on a specialized digital signal processor (DSP). In various examples, the systems and methods provided herein provide mean signal-to-noise ratio (SNR) gains around +8−9 dB with robust transcription/context selection under noise and overlap, and substantial latency/power savings versus CPU-only baselines.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order-dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking, or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example Context-Aware Speaker Prioritization System

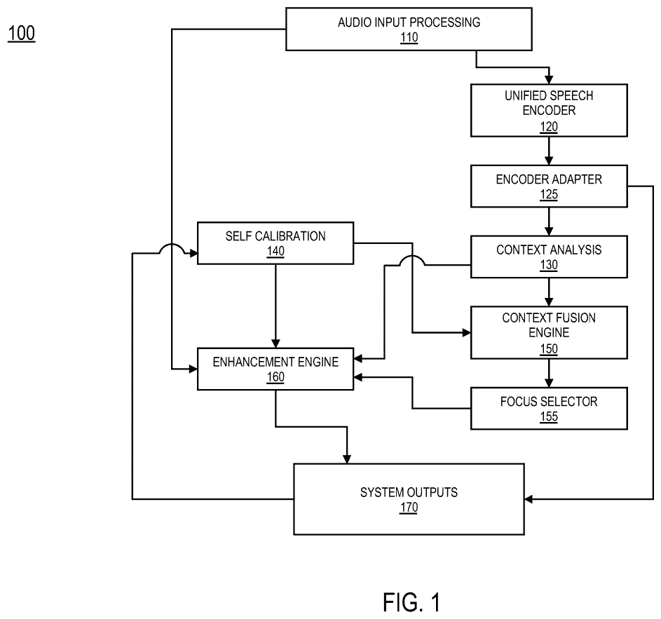

FIG. 1 is a block diagram illustrating an example architecture for a context-aware speaker prioritization system 100, according to various embodiments. The context-aware speaker prioritization system 100 includes an audio input processing module 110, a unified speech encoder 120, an encoder adapter module 125, a context analysis module 130, a self-calibration module 140, a context fusion engine 150, a focus selection module 155, an enhancement engine 160, and a system outputs module 170. According to various implementations, the context-aware speaker prioritization system 100 receives an audio input stream including speech from multiple speakers, determines which speaker to prioritize, enhances the audio corresponding to the speech from the prioritized speaker, and outputs the enhanced audio as well as a transcript of the audio.

The audio input processing module 110 receives the input audio stream. According to various implementations, the audio input processing module 110 includes a multi-speaker audio capture interface, a frame buffering submodule, and a synchronization submodule. The audio input processing module 110 can segment a continuous audio stream into analysis frames (for example, 20-40 ms) and can maintain a buffered copy of each frame for subsequent processing, such as for enhancement application at the enhancement engine 160. The audio input processing module 110 can also provide timing metadata used to align downstream token events with the original captured waveform. In some examples, the audio input processing module 110 can include a latency management submodule that aligns encoder processing time with the buffered frame horizon to ensure that enhancement is applied to the corresponding original audio frames, thereby maintaining frame-synchronous behavior across the pipeline. The audio input processing module 110 outputs the analysis frames to a unified speech encoder 120.

The unified speech encoder 120 includes a streaming speech-to-text (STT) encoder backbone and an internal representation emitter that produces, in a single processing pass, linguistic token data and acoustic speaker embeddings. The unified speech encoder 120 can generate tokens suitable for transcription and semantic analysis and, concurrently, can generate speaker-discriminative embeddings suitable for identity, activity, and continuity analysis. The unified speech encoder 120 can be backed by different encoder families (e.g., Whisper, Conformer, and/or wav2vec-style encoders). The unified speech encoder 120 preserves temporal synchrony between token and embedding outputs. According to various implementations, the unified speech encoder 120 outputs the stream of raw tokens and acoustic embeddings to the encoder adapter module 125.

The encoder adapter module 125 is a “universal translator” that receives the unified speech encoder 120 raw outputs and standardizes the outputs into canonical streams of data for input to downstream modules. Thus, the downstream modules receive consistent input data formatting regardless of the type of encoder the unified speech encoder 120 employs, enabling downstream modules to remain encoder agnostic and eliminating recalibration when different encoders are used. In various examples, the encoder adapter module 125 is an output formatter that exposes a canonical representation for token events and embeddings. In some examples, the encoder adapter module 125 outputs token events and timing and acoustic embeddings to the context analysis module 130, and the encoder adapter module 125 outputs transcript tokens to the system output module 170.

The context analysis module 130 includes a semantic analyzer submodule and a speaker identifier submodule. The semantic analyzer submodule receives the token events and timing, and can determine multi-dimensional semantic features, including content relevance scoring, vocabulary domain classification, keyword detection, turn-taking cues, role/authority indicators, and conversational continuity measures. The speaker identifier submodule receives the acoustic embeddings, and can form and update speaker patterns or clusters without pre-enrollment, determine similarities of the speaker patterns to evolving voice profiles, detect speaking activity, and apply temporal smoothing to maintain speaker continuity across frames. In some examples, the context analysis module 130 can include a role inference submodule that infers conversational roles (e.g., lecturer, chairperson, or participant) from token patterns and dialogue structure, and a continuity tracker submodule that distinguishes sustained discourse from brief interjections to stabilize prioritization in structured meetings. The context analysis module 130 outputs the semantic features and identity and activity features to the context fusion engine 150, as well as to the enhancement engine 160.

The context fusion engine 150 includes a priority scoring submodule and an adaptive weighting submodule. In some examples, the context fusion engine 150 also receives as input parameter adjustment data from the self-calibration module 140. The priority scoring submodule can determine, for each active speaker, a score that is a weighted combination of acoustic confidence from embeddings, semantic relevance from token analysis, role/authority, and keyword significance. The adaptive weighting submodule can adjust weighting coefficients responsive to operating conditions, profiles, and/or quality feedback, thereby biasing decisions toward semantic cues in high noise conditions or toward acoustic confidence in quieter conditions. In some examples, the context fusion engine 150 also includes a stability control submodule, which can apply hysteresis and smoothing to inhibit rapid switching among near-tied speakers. In some examples, the context fusion engine 150 outputs a ranked time-aligned list of active speakers. The list of active speakers can be arranged based on speaker priority in descending order, where speaker priority is determined at the priority scoring submodule. In some examples, the output from the context fusion engine 150 is received at a focus selector module 155.

The focus selector module 155 applies a selection policy to the data from the context fusion engine 150. In some examples, the selection policy can be a single speaker focus in a high noise profile. In some examples, the selection policy can be limited multi-speaker allowance in a hybrid meeting profile. The focus selector module 155 communicates a target selection to the enhancement engine 160.

An enhancement engine 160 receives the output from the context analysis module 130 (semantic features, identity features, and activity features), output from the focus selector module 155 (target selection information), output from the self-calibration module 140 and the audio frames from the audio input processing module 110. The enhancement engine 160 includes a mask generation submodule and an apply-to-waveform submodule. The mask generation submodule can synthesize a spectral emphasis or suppression profile conditioned on a selected primary speaker (as identified by the focus selector) and the associated acoustic embeddings. The apply-to-waveform submodule can apply the synthesized mask to the buffered copy of the original audio frames from the audio input processing module 110 to produce enhanced audio that emphasizes the selected speaker while preserving natural ambience. In some examples, the enhancement engine 160 can include a profile controller submodule that conditions mask aggressiveness and bandwidth emphasis according to deployment profiles, and a reconstruction submodule that reduces perceptual artifacts by enforcing temporal and spectral continuity constraints during mask application. The enhancement engine 160 outputs the enhanced audio to a system outputs module 170.

The system outputs module 170 includes an enhanced audio output interface and a transcript output interface. The system outputs module 170 can present enhanced audio resulting from the enhancement engine 160 and can generate a transcript annotated with speaker tags derived from the context analysis module 130 and the context fusion engine 150. The system outputs module 170 can also transmit quality samples to the self-calibration module 140.

The self-calibration module 140 includes a quality monitoring submodule and a parameter adjustment submodule. The quality monitoring submodule can receive enhanced audio and a transcript derived from token data and can determine indicators such as speaker switch stability, audio clarity (e.g., SNR/SIR proxies), semantic coherence, topical relevance, and artifact metrics. A quality assessment submodule can compare the indicators to thresholds and detect degradation trends. The parameter adjustment submodule can be a bounded update submodule and can transmit parameter updates to the context fusion engine 150 and the enhancement engine 160. In some examples, the parameter adjustment submodule can pause adaptation under multi-speaker overlap. In some examples, the parameter adjustment submodule can trigger a bypass mode when critical instability is detected. In some examples, the self-calibration module 140 can include a parameter history submodule that records recent adjustments to prevent oscillatory behavior, a rollback submodule that reverts changes when quality degrades, and a safety interlock submodule that suspends adaptation when double talk or severe non-stationarity is detected.

According to various implementations, inter-module signaling among the modules 110, 120, 125, 130, 140, 150, 155, 160, and 170 can include one or more of: token events with timestamps, acoustic embeddings and centroids, ranked speaker priorities, selection commands, spectral masks or statistics thereof, quality metrics, and bounded parameter updates. Such signaling can preserve temporal alignment between linguistic and acoustic evidence while enabling closed-loop optimization of prioritization and enhancement.

According to various implementations, the system 100 can operate in real-time by processing each frame once through the unified speech encoder 120, computing context aware priorities in the context fusion engine 150, applying the resulting enhancement to the buffered original audio in the enhancement engine 160, and using the self-calibration module 140 to maintain stability and intelligibility over time while delivering enhanced audio and speaker-tagged transcripts via the system outputs module 170.

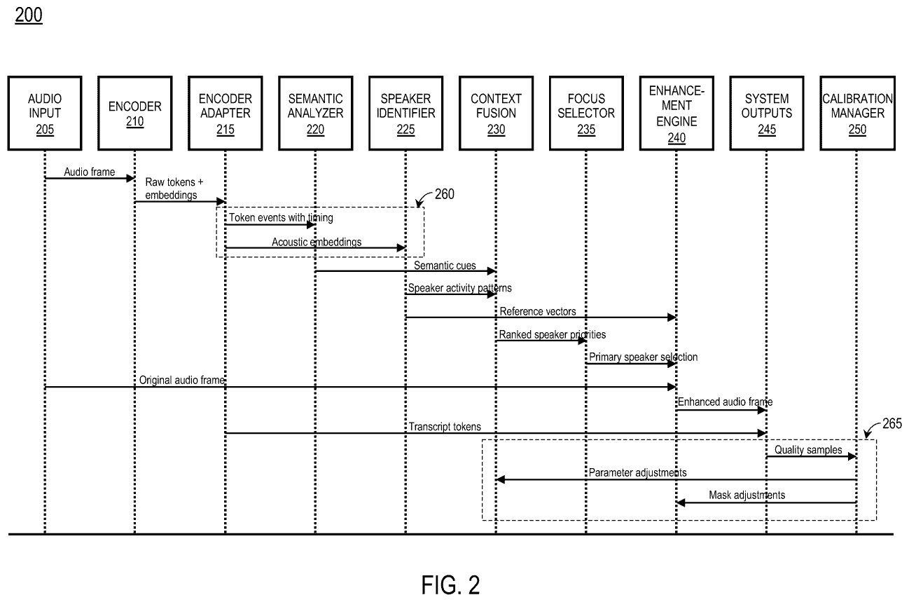

FIG. 2 is a block diagram illustrating a processing sequence 200 for a context-aware speaker prioritization system, according to various embodiments. In the processing sequence 200, a context-aware speaker prioritization system coordinates staged operations across audio input 205, encoder 210, encoder adapter 215, semantic analyzer 220, speaker identifier 225, context fusion 230, focus selector 235, enhancement engine 240, system output 245, and calibration manager 250. In operation, audio input 205 receives an audio input signal including speech from one or more speakers and segments the signal into analysis frames (for example, an audio frame with a buffered original audio frame) for subsequent processing.

The segmented frames are provided to encoder 210, which for each frame performs a single pass to concurrently produce linguistic token data and acoustic speaker embeddings (raw tokens+embeddings). The concurrent generation of linguistic token data and acoustic speaker embeddings maintains time alignment between the token stream and the embedding stream so that text-derived features and speaker identity features correspond to the same temporal interval of the audio.

Outputs of encoder 210 are normalized and standardized by encoder adapter 215. Consistent with an encoder agnostic adapter layer, encoder adapter 215 performs at least one of: selecting internal features of the speech-to-text encoder, normalizing values to a canonical range, temporally aligning output rates, and converting encoder-specific data structures to a canonical data format. As depicted by the dual analysis exchange 260, the encoder adapter 215 generates token events with timing to semantic analyzer 220 for text analysis and forwards acoustic embeddings to speaker identifier 225 for voice identification, while also passing transcript tokens to system outputs 245. In some examples, the transcript tokens can be used by the system outputs 245 to generate closed captions or a transcript.

Based on the token events, semantic analyzer 220 determines semantic features and emits semantic cues indicative of content relevance scoring, vocabulary domain classification, keyword detection, dialogue role indicators, turn-taking patterns, and conversational continuity measures. These features collectively characterize what is being said for each frame and remain synchronized to the corresponding acoustic evidence to support downstream multi-factor decision making. The semantic cues generated by the semantic analyzer 220 are received at context fusion 230.

In parallel, speaker identifier 225 identifies the one or more speakers using the acoustic embeddings. The speaker identifier 225 can identify the one or more speakers without pre-enrollment. Speaker identifier 225 can perform dynamic clustering, similarity computation to evolving speaker profiles, activity detection, and temporal smoothing to maintain speaker continuity across frames. The speaker identifier 225 outputs speaker activity patterns to decision logic and provides reference vectors (for example, centroids representing voiceprints) for conditioned enhancement of a selected speaker. In particular, the speaker identifier 225 outputs reference vectors to enhancement engine 240.

In various examples, the decision stage is implemented by context fusion 230, which determines a priority score for each active speaker using a weighted combination that may include: acoustic confidence derived from the speaker embedding analysis of speaker identifier 225, semantic relevance derived from the token analysis of semantic analyzer 220, role or authority indicators, and keyword significance. To inhibit rapid switching among speakers having similar scores, context fusion 230 applies stability control (for example, hysteresis and smoothing) and can adaptively update weights for the foregoing combination in response to operating context and calibration feedback. Context fusion 230 provides ranked speaker priorities to the focus selector 235.

Using the ranked list, focus selector 235 selects a primary speaker for the current frame (primary speaker selection) and transmits the selection to enhancement engine 240. Conditioned on at least the selected primary speaker and the associated reference vectors from speaker identifier 225, enhancement engine 240 generates a spectral emphasis mask and applies the spectral emphasis mask to a buffered copy of the corresponding original audio frames from audio input 205 to yield an enhanced audio frame that emphasizes the primary speaker. The enhanced audio frame generated by the enhancement engine 240 is transmitted to the system outputs 245. The system outputs 245 delivers, in parallel, the enhanced audio from the enhancement engine and the transcript tokens sourced from encoder adapter 215, preserving synchronized audio and text outputs.

In various implementations, runtime quality control is provided by calibration manager 250, which executes a self-calibration loop over an interval indicated by 265. System outputs 245 supplies quality samples of enhanced audio and transcript segments to calibration manager 250, which determines quality indicators including speaker switch stability, audio clarity, semantic coherence, content relevance, and artifact presence. When thresholds are met, calibration manager 250 issues parameter adjustments to context fusion 230 (for example, weight updates) and mask adjustments to enhancement engine 240 for subsequent frames, thereby maintaining intelligibility and selection accuracy during continuous operation.

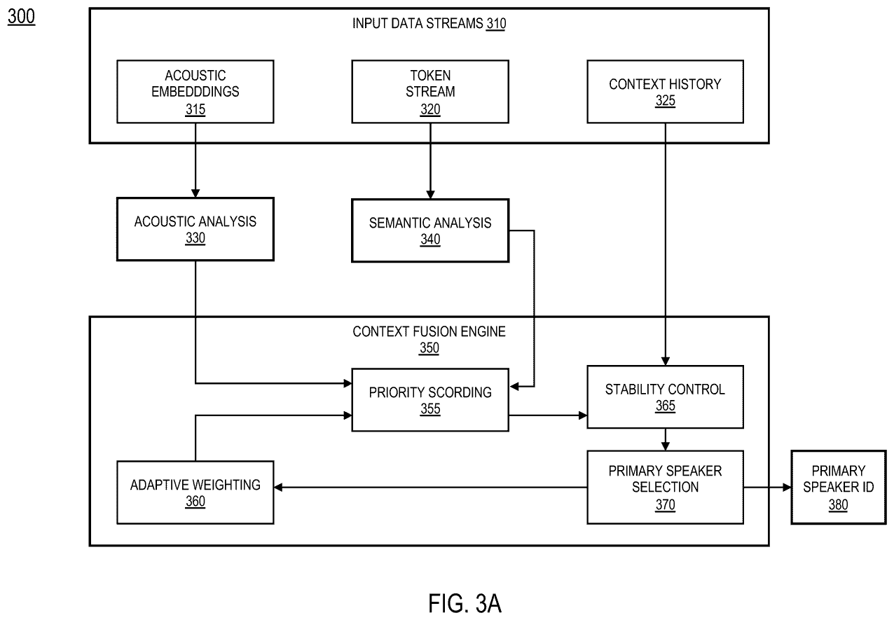

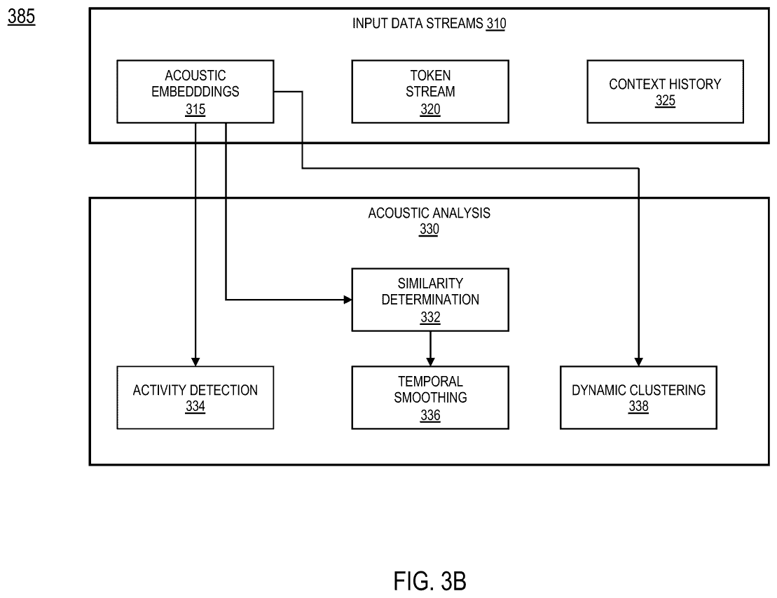

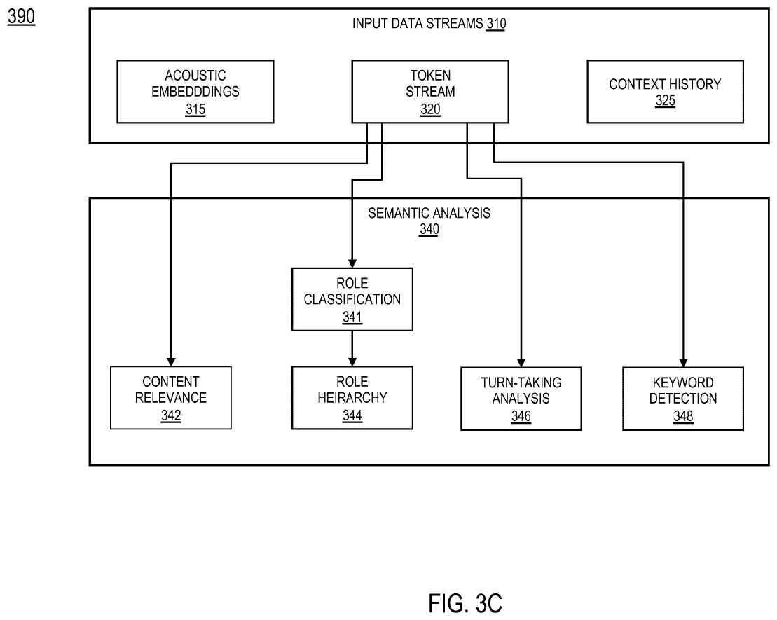

FIGS. 3A-3C are block diagrams 300, 385, 390 illustrating the multi-speaker context fusion process for a context-aware speaker prioritization system, according to various embodiments. FIG. 3A shows the input streams and the context fusion engine, FIG. 3B includes details of the acoustic analysis, and FIG. 3C includes details of the semantic analysis.

In FIG. 3A, a set of input data streams 310 provides acoustic embeddings 315, a token stream 320, and context history 325 for downstream processing. The acoustic embeddings 315 originate from a speech-to-text encoder that performs a single pass per frame to concurrently output linguistic token data and acoustic speaker embeddings. These streams feed into acoustic analysis 330 and semantic analysis 340, allowing the apparatus to determine semantic features from linguistic token data and to identify one or more speakers based on acoustic speaker embeddings. Context history 325 supplies stored information reflecting prior speaker selections, topic continuity, or historical stability, which supports temporal smoothing and decision consistency across frames.

FIG. 3B illustrates various components in the acoustic analysis module 330 in accordance with various embodiments. The acoustic analysis module 330 receives acoustic embeddings 315, which are frame synchronous embedding vectors generated by the speech-to-text encoder. The acoustic analysis module 330 includes multiple components that can operate on the acoustic embeddings 315, including a similarity determination component 332, an activity detection component 334, a temporal smoothing component 336, and a dynamic clustering component 338.

In some examples, the similarity determination component 332 determines a match between the incoming embedding and each known speaker prototype using a distance or similarity metric (e.g., cosine similarity). In some examples, the similarity determination component 332 may compare the match to the immediately preceding frame's assignment to detect continuity. In some examples, the similarity determination component 332 outputs a per-speaker similarity scores and a best-match speaker ID with a confidence value. The speaker similarity score and the best-match speaker ID and confidence value are forwarded to temporal smoothing component 336, and are provided to the context fusion engine 350 as acoustic confidence evidence for priority scoring.

In some examples, the activity detection component 334 determines whether the current frame contains active speech attributable to one or more speakers. In some examples, the activity detection component 334 estimates a frame-level activity likelihood and, when a best-match speaker ID is available from the similarity determination component 332, associates the activity likelihood with that speaker. In some examples, the activity detection component 334 outputs an activity flag or probability that gates subsequent model updates and candidate scoring. The activity flag or probability is provided to the context fusion engine 350 as part of the speaker activity pattern used as acoustic confidence evidence for priority scoring.

In some examples, the temporal smoothing component 336 receives the per-speaker similarity scores and best-match speaker ID with confidence produced by the similarity determination component 332, together with recent frame assignments and, in some implementations, the context history 325, and applies temporal continuity constraints to mitigate rapid oscillations in speaker identity. In some examples, the temporal smoothing component 336 outputs stabilized similarity scores and a continuity-aware speaker ID estimate for the current frame. The stabilized similarity scores and continuity-aware speaker ID estimate are provided to the context fusion engine 350 as temporally smoothed acoustic confidence inputs for priority scoring.

In some examples, the dynamic clustering component 338 receives acoustic embeddings 315. In some examples, the dynamic clustering component 338 can also receive the outputs from the other components of the acoustic analysis module 330. The dynamic clustering component 338 can maintain an online set of speaker prototypes (e.g., cluster centroids) that evolve over time. In some examples, the dynamic clustering component 338 determines whether the current embedding is attached to an existing cluster, whether the current embedding triggers creation of a new cluster representing a newly observed speaker, or whether the current embedding is ignored (e.g., when activity is below a threshold). The dynamic clustering component 338 updates cluster statistics incrementally. In some examples, the dynamic clustering component 338 outputs a cluster assignment (e.g., speaker ID) for the current frame. In some examples, the dynamic clustering component 338 outputs updated prototype vectors that summarize each speaker's acoustic characteristics. The cluster assignment and prototype vectors are provided to the context fusion engine 350 as speaker identity evidence and reference vectors that contribute to acoustic confidence during priority scoring.

In various implementations, the components 332, 334, 336, 338 of the acoustic analysis module 330 collectively determine acoustic confidence, track speaker activity, maintain continuity for speakers across frames, and form evolving speaker clusters. The resulting acoustic evidence is passed to the context fusion engine 350 as part of the multi-dimensional evaluation used to compute a priority score for each detected speaker.

FIG. 3C illustrates various components in the semantic analysis module 340 in accordance with various embodiments. The semantic analysis module 340 receives the token stream 320 and determines semantic features including content relevance 342, role classification 341, role hierarchy 344, turn-taking analysis 346, and keyword detection 348. These components evaluate the linguistic content of the utterances to determine semantic relevance, dialogue-role indicators, vocabulary-domain classification, turn-taking patterns, continuity of discourse, and keyword significance. In some examples, the semantic analysis 340 also receives the context history 325. The outputs are delivered to the context fusion engine 350 to support determining semantic relevance and role or authority indicators as described in the claims.

In some examples, the content relevance component 342 receives the token stream 320 and determines whether the current utterance is on topic for the ongoing conversation (for example, meeting content versus environmental chatter). In some examples, the content relevance component 342 computes a semantic relevance score that reflects how closely the text aligns with established topics and prior discourse. In some examples, the semantic relevance score is provided to the context fusion engine 350 as semantic evidence for priority scoring.

In some examples, the role classification component 341 receives the token stream 320 and infers dialogue roles for the speaking party, such as lecturer, chair, or participant, based on linguistic patterns and conversational structure. In some examples, the role classification component 341 outputs a role label associated with the current utterance. In some examples, the role label is provided to the role hierarchy component 344 and is also supplied to the context fusion engine 350 as a role indicator used for priority scoring.

In some examples, the role hierarchy component 344 receives the role label from the role classification component 341 and maps the label to a hierarchical importance consistent with meeting protocol. In some examples, the role hierarchy component 344 assigns a baseline authority value that can elevate speakers holding procedural or leadership roles. In some examples, the baseline authority value is provided to the context fusion engine 350 as a role authority indicator used in priority scoring.

In some examples, the turn taking analysis component 346 receives the token stream 320 and identifies conversational events such as interruptions and handoffs. In some examples, the turn taking analysis component 346 receives input from the context history 325. In some examples, the turn taking analysis component 346 produces cues that characterize whether the current contribution reflects a transfer of the floor or competing speech. In some examples, these turn taking cues are provided to the context fusion engine 350 as semantic evidence used for stable prioritization.

In some examples, the keyword detection component 348 receives the token stream 320 and detects terms of special significance, including command phrases, names, and urgent terms. In some examples, the keyword detection component 348 outputs a keyword flag or significance score associated with the detected term. In some examples, the keyword flag or significance score is provided to the context fusion engine 350 as keyword evidence for priority scoring.

Referring to FIG. 3A, the context fusion engine 350 combines the acoustic evidence from acoustic analysis 330 and the semantic evidence from semantic analysis 340.

Priority scoring 355 receives semantic cues (including content relevance, roles, turn taking, and keywords), acoustic cues (including similarity and activity), and dynamic weights from adaptive weighting 360, and determines a raw priority score for each active speaker according to a weighted combination that may include weighted values for acoustic confidence, semantic relevance, role or authority indicators, and keyword significance. The raw priority scores are forwarded to stability control 365.

Stability control 365 receives the raw priority scores together with the context history 325 and applies hysteresis and smoothing to inhibit rapid switching among speakers having similar scores, and produces stabilized scores. The stabilized scores are provided to primary speaker selection 370. Primary speaker selection 370 operates as a sorter that organizes the stabilized scores into a ranked speaker priorities list, identifies a “winner” (i.e., the speaker who has priority) for the current frame, and outputs a primary speaker ID 380 that identifies the speaker to be emphasized. In some implementations, the ranked list can also be delivered to a focus selector, as described above.

Adaptive weighting 360 receives current state information from primary speaker selection 370 and generates updated dynamic weights for use by priority scoring 355. In operation, adaptive weighting 360 tunes the relative contributions of acoustic confidence, semantic relevance, role authority, and keyword significance in response to operating conditions and calibration feedback. This closed-loop adjustment maintains stable, context-appropriate prioritization across frames.

Thus, the components illustrated in FIGS. 3A-3C provide the internal decision logic used by the apparatus to determine, for each audio frame, the most contextually important speaker by integrating acoustic embeddings, linguistic token data, and contextual history. These modules collectively support priority scoring, stability controls, adaptive weighting, and primary speaker selection that is ultimately used by downstream enhancement operations to generate a spectral emphasis mask conditioned on the selected primary speaker and to apply the mask to the corresponding original audio frame.

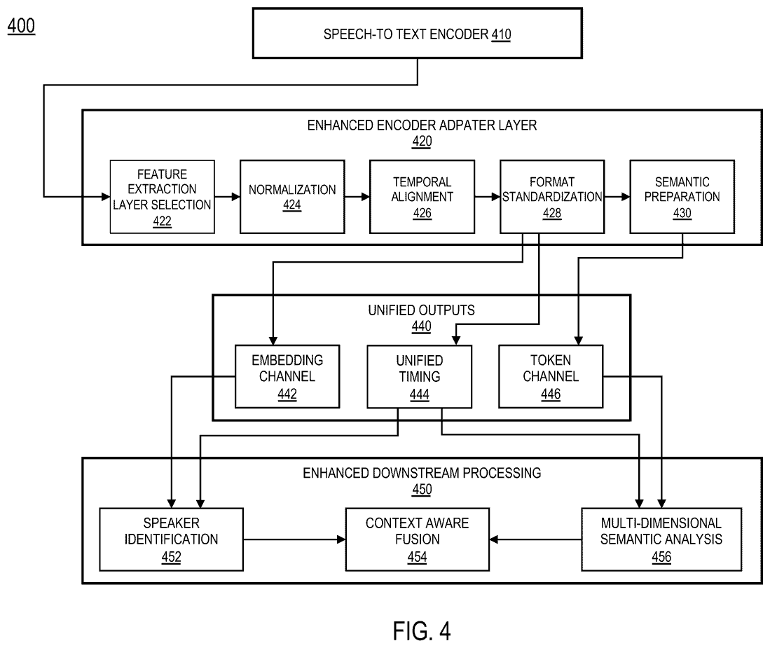

FIG. 4 is a block diagram 400 illustrating an encoder-agnostic adapter for a context-aware speaker prioritization system, according to various embodiments. A speech-to-text encoder 410 provides raw model outputs to an enhanced encoder adapter layer 420. The enhanced encoder adapter layer 420 includes feature extraction layer selection 422, normalization 424, temporal alignment 426, format standardization 428, and semantic preparation 430. The enhanced encoder adapter layer 420 emits unified outputs 440 including an embedding channel 442, unified timing 444, and a token channel 446. The unified outputs 440 are transmitted to an enhanced downstream processing module 450. The enhanced downstream processing module 450 includes a speaker identification 452, a context aware fusion 454, and multi-dimensional semantic analysis 456.

In some examples, speech-to-text encoder 410 processes each audio frame in a single pass to concurrently generate linguistic token data and acoustic speaker embeddings. The concurrent emission preserves time alignment between token hypotheses and the corresponding acoustic representations so that downstream modules operate on synchronized evidence drawn from the same frame interval. In various examples, the speech-to-text encoder 410 can be any type of speech-to-text encoder (e.g., Whisper, Conformer, Wav2Vec, etc.) and generate any type of output (e.g., Hidden States, Projections, etc.). The enhanced encoder adapter layer 420 processes the output and generates a standardized output. In particular, the encoder's outputs are supplied to the enhanced encoder adapter layer 420 for encoder-agnostic preparation.

At the enhanced encoder adapter layer 420, the output from the encoder 410 is received at a feature extraction layer selection 422. In some examples, feature extraction layer selection 422 selects encoder internal features that carry speaker discriminative information and token events suitable for semantic analysis. Normalization 424 maps heterogeneous encoder value ranges into a canonical scale expected by downstream modules. Temporal alignment 426 rate matches and aligns encoder emission intervals to a common frame cadence, while format standardization 428 converts encoder-specific structures into a canonical data format. Semantic preparation 430 organizes token events and related metadata so they are ready for multi-dimensional semantic analysis. Together, the operations performed in the enhanced encoder adapter layer 420 implement an encoder-agnostic adapter that standardizes outputs. The output from the enhanced encoder adapter layer 420 is input to the unified outputs 440. In particular, the output from format standardization 428 is input to embedding channel 442 and to unified timing 444, and the output from semantic preparation 430 is input to token channel 446.

In some examples, unified outputs 440 provide three coordinated streams. The embedding channel 442 delivers normalized acoustic speaker embeddings that can be used for identity, similarity, and clustering operations. In various examples, the token channel 446 delivers standardized token events for content relevance, role indicators, turn taking, and keyword analysis. In some examples, unified timing 444 carries synchronized timestamps that maintain the time alignment between embeddings and tokens.

In some examples, enhanced downstream processing 450 consumes the unified outputs 440. Speaker identification 452 uses the embedding channel 442 (with unified timing 444) to produce speaker activity patterns, similarity measures, and reference vectors that characterize speakers without using speaker pre-enrollment. Multi-dimensional semantic analysis 456 uses the token channel 446 (with unified timing 444) to determine semantic features, including content relevance, vocabulary domain cues, dialogue role indicators, turn taking patterns, and keyword significance. Context-aware fusion 454 combines acoustic and semantic evidence using a weighted combination that may include acoustic confidence, semantic relevance, role or authority indicators, and keyword significance, thereby determining per-speaker priority scores.

In some examples, the outputs of context-aware fusion 454 are consumable by a focus selector to select a primary speaker, and the reference vectors from speaker identification 452 are usable by an enhancement engine to generate a spectral emphasis mask conditioned on the selected primary speaker and the associated embeddings. The mask can be applied to a buffered copy of the corresponding original audio frames to produce enhanced audio that emphasizes the primary speaker.

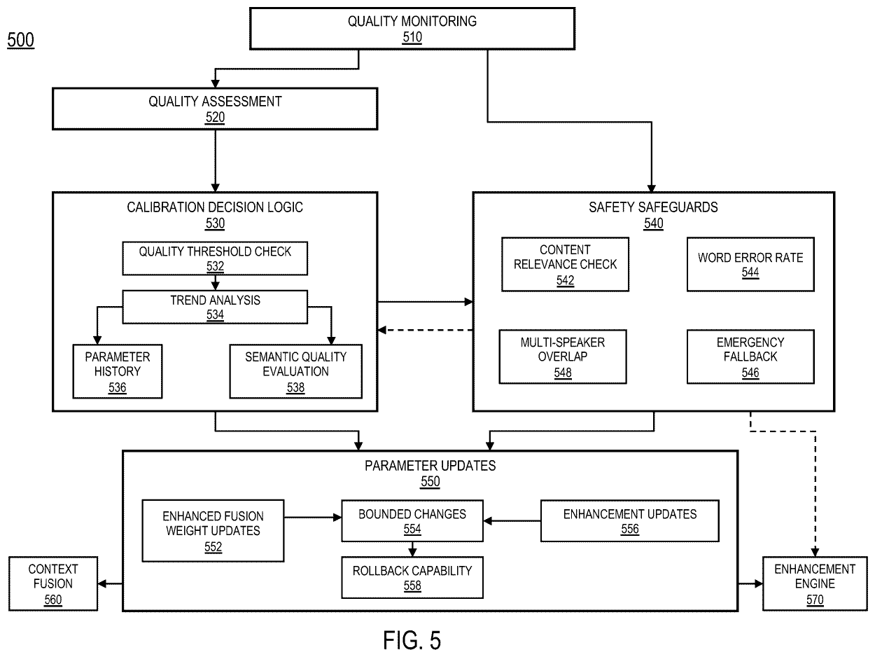

FIG. 5 is a block diagram 500 illustrating a self-calibration feedback loop for a context-aware speaker prioritization system, according to various embodiments. In particular, in the self-calibration pipeline of FIG. 5, a quality monitoring component 510 receives the enhanced audio input and the transcript produced from token data by a system outputs (e.g., system outputs 170, 245). The quality monitoring component 510 aligns the audio and text streams in time and forwards synchronized samples to downstream analysis so that subsequent decisions reflect the same frame interval as a context fusion engine (e.g., context fusion engine 150, 350) and an audio enhancement engine (e.g., enhancement engine 160, 240). The monitoring includes continuously observing the outputs that result from selecting a primary speaker and applying a spectral emphasis mask to a buffered copy of the corresponding original audio frames.

A quality assessment component 520 evaluates multiple quality indicators derived from the monitored streams. In some examples, the quality assessment component 520 includes various analysis blocks, including speaker switch stability (measuring the rate of switches among candidates), audio clarity (e.g., SNR/SIR based measures), semantic coherence (language consistency proxies on the transcript), content relevance (topic match to ongoing discourse), and artifact detection (spectral discontinuity checks). The outputs of these assessments are provided as inputs to calibration decision logic 530 and correspond to the quality indicators such as speaker switch stability, audio clarity, semantic coherence, content relevance, and artifact presence.

Calibration decision logic 530 determines whether updates are warranted based on the assessed indicators. Within calibration decision logic 530, a quality threshold check 532 and a trend analysis 534 operate together to detect persistent degradation. Additionally, parameter history 536 records recent adjustments to avoid oscillation, and semantic quality evaluation 538 ensures proposed updates are contextually sound. In some examples, the calibration decision logic 530 also utilizes labeled signals including focus alert and quality alert. Focus alert can be raised based on content relevance indicating that attention appears misdirected. Quality alert can be raised based on recognition quality conditions indicating that quality has fallen below acceptable bounds. In some examples, the calibration decision logic 530 can defer adaptation during ambiguous conditions.

A safety safeguards component 540 supervises adaptation and runtime fail-safe responses. The safety safeguards component 540 includes content relevance check 542, word error rate 544, emergency fallback 546, and multi-speaker overlap 548. In operation, safety safeguards 540 can issue focus alerts to calibration decision logic 530, and the safety safeguards 540 can issue quality alerts to emergency fallback 546. In some examples, the safety safeguards can issue bypass mode to enhancement engine 570. Additionally, safety safeguards 540 can transmit a pause updates instruction to the parameter updates component 550 to temporarily suspend adaptation during multi-speaker overlap 548. In some examples, the safety safeguards 540 can trigger bypass mode (shown by the dashed path from safety safeguards 540 to enhancement engine 570) to route audio around parameter updates 550 and further enhancement when emergency fallback 546 is activated.

When adaptation is approved, parameter updates 550 applies bounded and reversible changes. Enhanced fusion weight updates 552 issue parameter updates to context fusion 560 so that the weighted combination used in priority scoring (e.g., acoustic confidence, semantic relevance, role/authority indicators, and keyword significance) reflects current conditions. In some examples, bounded changes 554 ensure safe ranges and work with rollback capability 558 to revert if quality degrades. In some examples, enhancement updates 556 issue mask updates to enhancement engine 570 to refine spectral emphasis on the selected primary speaker. The various adjustments performed at parameter updates 550 correspond to automatic updates of context fusion weights and enhancement mask parameters for subsequent frames.

According to various implementations, quality monitoring 510, quality assessment 520, calibration decision logic 530, safety safeguards 540, and parameter updates 550 implement a self-calibration loop that monitors enhanced audio and transcript outputs, determines quality indicators, and safely adapts both prioritization and enhancement behavior. By incorporating pause updates, focus alert, quality alert, bypass mode, parameter updates, and mask updates, the system illustrated in FIG. 5 ensures stable operation that inhibits rapid switching, maintains synchronized audio and text outputs, and preserves intelligibility while emphasizing the primary speaker selected from the weighted combination of acoustic and semantic evidence.

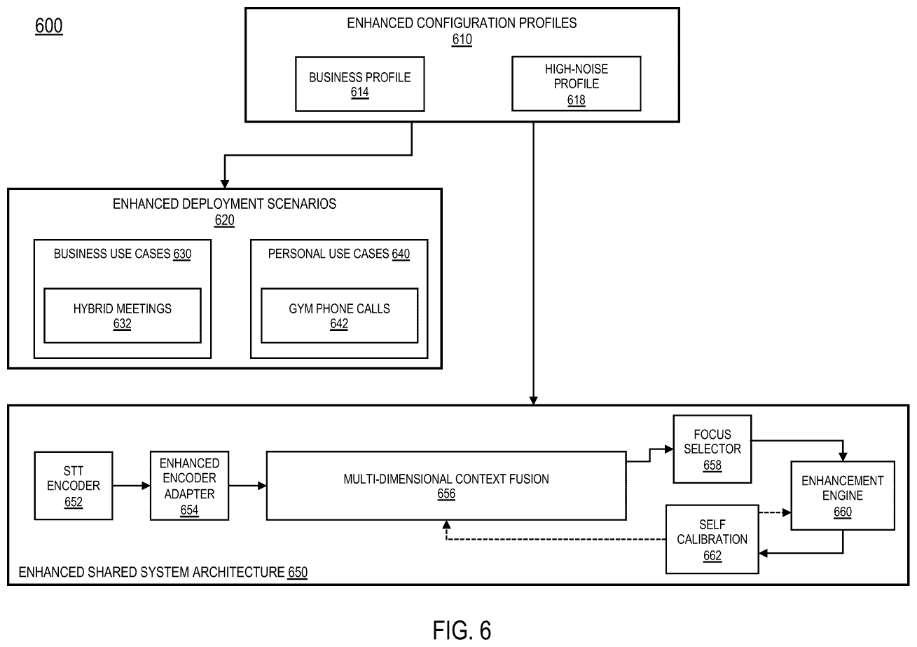

FIG. 6 is a block diagram 600 illustrating use case deployment scenarios for a context-aware speaker prioritization system, according to various embodiments. As shown in FIG. 6, enhanced configuration profiles 610 supply preset operating parameters to enhanced deployment scenarios 620 so that the same pipeline behaves appropriately across different environments. Within enhanced configuration profiles 610, a business profile 614 and a high noise profile 618 are defined, and are applied to business use cases 630 and personal use cases 640, respectively. In the illustrated scenarios, business use cases 630 include hybrid meetings 632, while personal use cases 640 include gym phone calls 642. These profiles parameterize downstream weighting used for speaker prioritization so that meeting-relevant dialogue is emphasized in hybrid meetings 632 and content-relevant speech is preserved in high-noise gym phone calls 642.

An enhanced shared system architecture 650 executes the frame-synchronous processing. A STT encoder 652 receives an audio input signal and, for each segmented frame, performs a single pass that concurrently emits linguistic token data and acoustic speaker embeddings. Outputs of the STT encoder 652 are standardized by an enhanced encoder adapter 654 that performs feature selection, normalization, temporal alignment, and format unification so that tokens and embeddings are available as canonical streams and remain time-aligned for downstream analysis.

Multi-dimensional context fusion 656 combines acoustic evidence derived from the embeddings with semantic features derived from the tokens to determine a per-speaker priority score. In some examples, the score is determined by a weighted combination that includes acoustic confidence, semantic relevance, role or authority indicators, and keyword significance. The relative weights can be established by the active profile and can be subject to stability control to inhibit rapid switching among near-tied speakers. The ranked result is provided to a focus selector 658, which selects a primary speaker for the current frame in accordance with the profile's selection policy.

An enhancement engine 660 generates a spectral emphasis mask conditioned on at least the selected primary speaker and the associated speaker embeddings. The enhancement engine 660 applies the mask to a buffered copy of the corresponding original audio frames to produce enhanced audio that emphasizes the primary speaker. The same unified timing supplied by the adapter preserves synchronization between the enhanced audio and the transcript generated from token data. The reference vectors used by enhancement engine 660 are derived from the embedding channel and reflect the identity information established during prioritization.

A self-calibration component 662 closes the loop by monitoring enhanced audio and transcript outputs and providing parameter adjustments to multi-dimensional context fusion 656 and enhancement engine 660 for subsequent frames. In some examples, self-calibration 662 adapts the weighting used by multi-dimensional context fusion 656 and refines mask parameters in enhancement engine 660. In various examples, the components 610, 620, and 650 realize profile-driven deployment. In various examples, a business profile 614 and a high-noise profile 618 initialize the weights used by multi-dimensional context fusion 656 for hybrid meetings 632 and gym phone calls 642, and self-calibration 662 sustains quality by automatically updating context fusion weights and enhancement mask parameters over time.

FIG. 6 illustrates an example including business and high-noise configuration profiles, and business and personal use cases. In various examples, many other enhanced configuration profiles can be used. Similarly, many other development scenarios can be included. For example, enhanced configuration profiles 610 can include an educational profile, an accessibility profile, personal profiles, etc. In some examples, enhanced deployment scenarios 620 can include educational use cases, and accessibility use cases. The additional contexts can include interactive lectures and Q&A, corporate training sessions, and language learning environments where instructor roles and question events are emphasized for remote and in-room participants. Other contexts include professional settings such as client presentations and sales calls, and board meetings and executive sessions where procedural language and handoffs are respected. In various examples, personal and public settings can include restaurant and social dining and outdoor or travel communications where announcement systems and environmental noise are managed while preserving conversation. In some examples, assistive applications including hearing assistance in social settings, real-time captioning for educational access, and professional accessibility support, in which on-topic educational or workplace content is prioritized while background chatter is reduced.

### Example Method for Context-Aware Speaker Prioritization

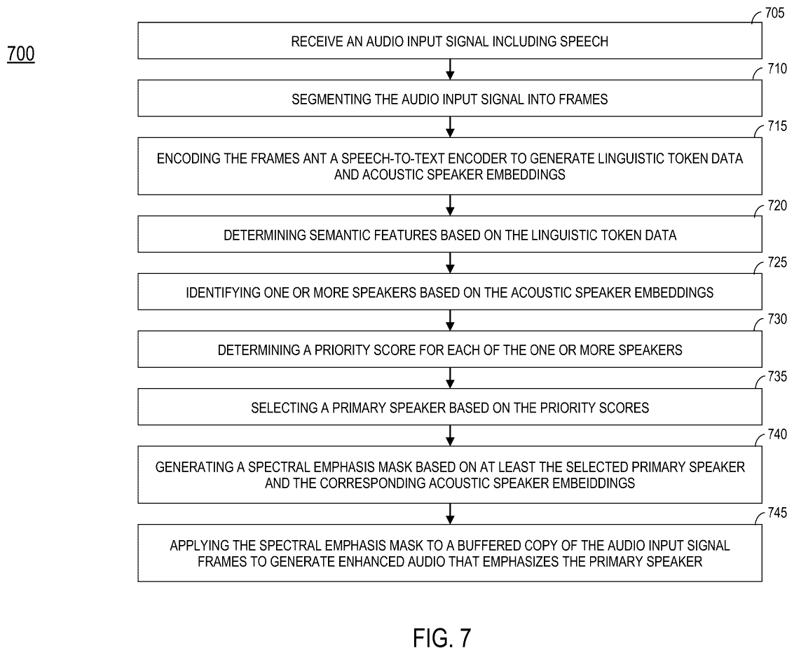

FIG. 7 illustrates a method 700 that can be used for context-aware speaker prioritization, in accordance with various embodiments. In particular, the method 700 is an example method for speaker prioritization in multi-speaker environments. Although the method 700 is described with reference to the flowchart illustrated in FIG. 7, many other methods for context-aware speaker prioritization may alternatively be used. For example, the order of execution of the elements in FIG. 7 may be changed. As another example, some of the steps may be changed, eliminated, or combined. In various examples, the method 700 can be implemented by a context-aware speaker prioritization system, such as the context-aware speaker prioritization system 100 of FIG. 1 or the context-aware speaker prioritization processing sequence 200 of FIG. 2.

At 705, an audio input signal is received, and the audio input signal includes speech from one or more speakers. At 710, the audio input signal is segmented into frames suitable for real-time processing. At 715, each frame is encoded at a speech-to-text encoder. In various examples, each frame is encoded in a single pass that concurrently generates linguistic token data and acoustic speaker embeddings, thereby preserving time alignment between the token stream and the embedding stream for the same frame interval. In some examples, the outputs of the speech-to-text encoder are standardized by an encoder-agnostic adapter layer before downstream consumption. The encoder-agnostic adapter layer selects encoder internal features, normalizes values to a canonical range, temporally aligns output rates to a common cadence, and converts encoder-specific structures to a canonical data format, producing synchronized streams of token events and acoustic embeddings. This encoder-agnostic adapter layer behavior allows for uniform operation of subsequent components regardless of the underlying encoder model. Additionally, the encoder-agnostic adapter layer maintains the time alignment between the linguistic token data and the acoustic speaker.

At 720, semantic features are determined based on the linguistic token data. The semantic features can include one or more of content relevance scoring to the current discourse, vocabulary domain classification, keyword detection, dialogue role indicators, turn-taking patterns, and conversational continuity measures.

At 725, one or more speakers are identified based on the acoustic speaker embeddings by performing at least one of dynamic clustering to maintain evolving speaker profiles, similarity computation against such profiles, activity detection to determine when a speaker is active, and temporal smoothing to preserve speaker continuity across adjacent frames. The one or more speakers are identified without pre-enrollment.

At 730, a context fusion engine determines a priority score for each active speaker by combining multi-dimensional evidence. In some examples, the priority score is a weighted combination that includes acoustic confidence derived from analysis of the acoustic speaker embeddings, semantic relevance derived from analysis of the linguistic token data, role indicators, and keyword significance. To avoid rapid switching among near-tied speakers, stability control applies hysteresis or smoothing. Additionally, adaptive weighting updates the weighting coefficients responsive to operating conditions and calibration feedback, while optionally consulting recent context history to maintain stable transitions.

At 735, a focus selector selects a primary speaker based on the priority scores produced by the context fusion engine. The selection policy can be configured by profile and yields an identification of the primary speaker for the current frame together with selection metadata usable by downstream modules. The ranked list of candidates can also be retained for audit or secondary uses.

At 740, an enhancement engine generates a spectral emphasis mask based on at least the selected primary speaker and the corresponding acoustic speaker embeddings, such as reference vectors produced during identification.

At 745, the enhancement engine applies the spectral emphasis mask to a buffered copy of the audio input signal frames to generate enhanced audio that emphasizes the primary speaker while preserving naturalness. Because the token data and embeddings are time-aligned to the same frame cadence, the enhanced audio remains synchronized with the transcript derived from the token stream.

In some examples, the method further includes a self-calibration loop that monitors the enhanced audio and a transcript produced from the linguistic token data to determine quality indicators. The indicators can include one or more of speaker switch stability, audio clarity, semantic coherence, content relevance, and artifact presence. When thresholds or trends indicate degradation, the self-calibration loop automatically adjusts parameters for subsequent frames, including at least the weighting coefficients used by the context fusion engine for priority scoring and the parameters of the spectral emphasis mask used by the enhancement engine, with bounded changes and rollback safeguards to maintain stable operation.

### Example Deep Neural Network System

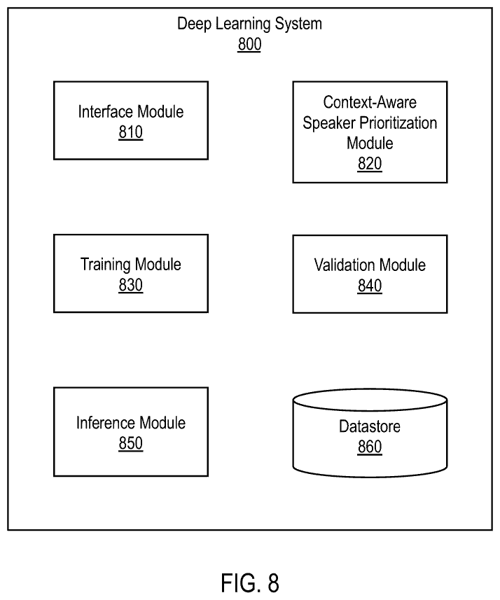

FIG. 8 is a block diagram of a deep learning system 800 that can be used for context-aware speaker prioritization, in accordance with various embodiments. In some embodiments, the deep learning system 800 is a deep neural network (DNN). The deep learning system 800 trains DNNs for various tasks, including, for example, speaker prioritization in multi-speaker environments. In the embodiments of FIG. 8, the deep learning system 800 includes an interface module 810, a training module 830, a validation module 840, a context-aware speaker prioritization module 820, and a datastore 860. In other embodiments, alternative configurations, different or additional components may be included in the deep learning system 800. Further, functionality attributed to a component of the deep learning system 800 may be accomplished by a different component included in the deep learning system 800 or a different module or system, such as any of the neural networks and/or deep learning systems described herein.

In some examples, the deep learning system 800 includes a lightweight model architecture that is both memory and compute efficient. The model can include a recurrent neural network (RNN). A RNN is a type of artificial neural network that can be used to process sequential data such as audio signals. In some embodiments, the RNN features one or more GRU layers and one or more fully connected layers.

The interface module 810 facilitates communication of the deep learning system 800 with other modules or systems. For example, the interface module 810 establishes communication between the deep learning system 800 and an external database to receive data that can be used to train DNNs or input into DNNs to perform tasks. As another example, the interface module 810 supports the deep learning system 800 to distribute DNNs to other systems, e.g., computing devices configured to apply DNNs to perform tasks.

In an embodiment where the training module 830 trains a DNN to prioritize a speaker in a multi-speaker signal, the training module 830 can compare the signal prioritized by the DNN to the signal of the priority speaker, which can serve as ground truth. In some embodiments, a part of the training dataset may be used to initially train the DNN, and the rest of the training dataset may be held back as a validation subset used by the validating module 840 to validate the performance of a trained DNN. The portion of the training dataset not including the tuning subset and the validation subset may be used to train the DNN.

The training module 830 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as the number of hidden layers, etc. Hyperparameters also include variables that determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 3, 30, 300, 400, or even larger.

The training module 830 defines the architecture of the DNN, e.g., based on some of the hyperparameters. In some examples, the architecture of the DNN includes multiple layers, such as an input layer, an output layer, and a plurality of hidden layers. The input layer of a DNN may include tensors (e.g., a multidimensional array) specifying attributes of the input signal, such as frequency, volume, and other spectral characteristics. The output layer includes labels of angles and/or locations of sound sources in the input signal. The hidden layers are layers between the input layer and output layer. The hidden layers include one or more GRU layers and one or more other types of layers, such as fully connected layers, convolutional layers, pooling layers, normalization layers, SoftMax or logistic layers, and so on. While the DNN described with respect to FIG. 5 is a RNN, in other embodiments, different types of DNNs can be used. In some examples, GRU layers or convolutional layers of the DNN abstract the input signals to perform feature extraction. In some examples, the feature extraction is based on a spectrogram of an input sound signal. A pooling layer can be used to reduce the volume of the input signal after convolution. It is used between two convolutional layers. A fully connected layer involves weights, biases, and neurons. It connects neurons in one layer to neurons in another layer. It is used to classify signals between different categories by training. Note that training a DNN is different from using the DNN in real-time, and when using a DNN to process data that is received in real-time, latency can become an issue that is not present during training, when the dataset can be pre-loaded.

In the process of defining the architecture of the DNN, the training module 830 also adds an activation function to a hidden layer or the output layer. An activation function of a layer transforms the weighted sum of the input of the layer into an output of the layer. The activation function may be, for example, a rectified linear unit activation function, a tangent activation function, or other types of activation functions.

After the training module 830 defines the architecture of the DNN, the training module 830 inputs a training dataset into the DNN. The training dataset includes a plurality of training samples. An example of a training sample includes the source location of a feature in an audio sample and a ground-truth location of the feature. The training module 830 modifies the parameters inside the DNN (“internal parameters of the DNN”) to minimize the error between labels of the training features that are generated by the DNN and the ground-truth labels of the features. The internal parameters include weights of filters in the convolutional layers of the DNN. In some embodiments, the training module 830 uses a cost function to minimize the error.

The training module 830 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 830 finishes the predetermined number of epochs, the training module 830 may stop updating the parameters in the DNN. The DNN having the updated parameters is referred to as a trained DNN.

The validation module 840 verifies the accuracy of trained or compressed DNNs. In some embodiments, the validation module 840 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 840 may determine an accuracy score measuring the precision, recall, or a combination of precision and recall of the DNN. The validation module 840 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2* PR/(P+R)) unifies precision and recall into a single measure.

The validation module 840 may compare the accuracy score with a threshold score. In an example where the validation module 840 determines that the accuracy score of the augmented model is less than the threshold score, the validation module 840 instructs the training module 830 to re-train the DNN. In one embodiment, the training module 830 may iteratively re-train the DNN until the occurrence of a stopping condition, such as the accuracy measurement indicating that the DNN may be sufficiently accurate, or a number of training rounds having taken place.

The inference module 850 applies the trained or validated DNN to perform tasks. The inference module 850 may run inference processes of a trained or validated DNN. In some examples, inference makes use of the forward pass to produce model-generated output for unlabeled real-world data. For instance, the inference module 850 may input real-world data into the DNN and receive an output of the DNN. The output of the DNN may provide a solution to the task for which the DNN is trained.

The inference module 850 may aggregate the outputs of the DNN to generate a final result of the inference process. In some embodiments, the inference module 850 may distribute the DNN to other systems, e.g., computing devices in communication with the deep learning system 800, for the other systems to apply the DNN to perform the tasks. The distribution of the DNN may be done through the interface module 810. The computing devices may be connected to the deep learning system 800 through a network.

In some implementations, the DNN may include a convolution module, which can perform voice transformation. In some examples, the convolution module 820 can also perform additional real-time data processing, such as for speech enhancement, and/or dynamic noise suppression. The convolution module can include a time domain encoder, a frequency domain encoder, and a time domain decoder. In some examples, the time domain encoder is a convolutional time domain encoder, the frequency domain encoder is a convolutional frequency domain spectrum encoder, and the time domain decoder is a convolutional time domain decoder. In other embodiments, alternative configurations, different or additional components may be included in the convolution module. Further, functionality attributed to a component of the convolution module may be accomplished by a different component included in the convolution module, the deep learning system 800, or a different module or system.

The frequency encoder receives STFT spectra. In various examples, the input data to the frequency encoder is frequency domain STFT spectra derived from input audio data. The input data includes input tensors which can each include multiple frames of data.

In various examples, a STFT is a Fourier-related transform used to determine the sinusoidal frequency and phase content of local sections of a signal as it changes over time. Generally, STFTs are computed by dividing a longer time signal into shorter segments of equal length and then computing the Fourier transform separately on each shorter segment. This results in the Fourier spectrum on each shorter segment. The changing spectra can be plotted as a function of time, for instance, as a spectrogram. In some examples, the STFT is a discrete-time STFT, such that the data to be transformed is broken up into tensors or frames (which usually overlap each other, to reduce artifacts at the boundary). Each tensor or frame is Fourier transformed, and the complex result is added to a matrix, which records magnitude and phase for each point in time and frequency. In some examples, an input tensor has a size of H×W×C, where H denotes the height of the input tensor (e.g., the number of rows in the input tensor or the number of data elements in a row), W denotes the width of the input tensor (e.g., the number of columns in the input tensor or the number of data elements in a row), and C denotes the depth of the input tensor (e.g., the number of input channels).

An inverse STFT can be generated by inverting the STFT. In various examples, the STFT is processed by the DNN, and it is then inverted at the decoder, or before being input to the decoder. By inverting the STFT, the encoded frequency domain signal from the frequency encoder can be recombined with the encoded time domain signal from the time encoder. One way of inverting the STFT is by using the overlap-add method, which also allows for modifications to the STFT complex spectrum. This makes for a versatile signal processing method, referred to as the overlap and add with modifications method. In various examples, the output from the decoder is an audio output signal representing the input signal for a selected audio source. In some examples, the output from the decoder includes multiple separated audio output signals, each representing the input signal for a respective input audio source.

The datastore 860 stores data received, generated, used, or otherwise associated with the deep learning system 800. For example, the datastore 860 stores the datasets used by the training module 830 and validation module 840. The datastore 860 may also store data such as the hyperparameters for training DNNs, internal parameters of trained DNNs (e.g., weights, etc.), data for sparsity acceleration (e.g., sparsity bitmap, etc.), and so on. In some embodiments, the datastore 860 is a component of the deep learning system 800. In other embodiments, the datastore 860 may be external to the deep learning system 800 and communicate with the deep learning system 800 through a network.

### Example Computing Device

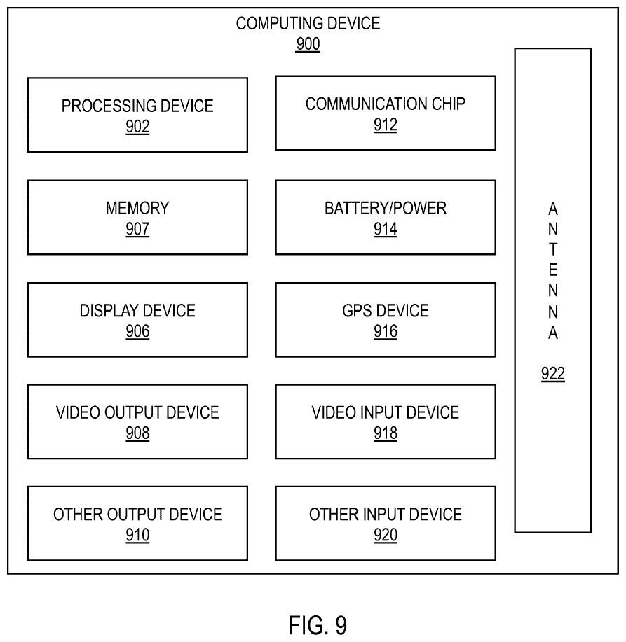

FIG. 9 is a block diagram of an example computing device 900, in accordance with various embodiments. In some embodiments, the computing device 900 may be used for at least part of the systems in FIGS. 1-6. A number of components are illustrated in FIG. 9 as included in the computing device 900, but any one or more of these components may be omitted or duplicated, as suitable for the application. In some embodiments, some or all of the components included in the computing device 900 may be attached to one or more motherboards. In some embodiments, some or all of these components are fabricated onto a single system on a chip (SoC) die. Additionally, in various embodiments, the computing device 900 may not include one or more of the components illustrated in FIG. 9, but the computing device 900 may include interface circuitry for coupling to the one or more components. For example, the computing device 900 may not include a display device 906, but may include display device interface circuitry (e.g., a connector and driver circuitry) to which a display device 906 may be coupled. In another set of examples, the computing device 900 may not include a video input device 918 or a video output device 908, but may include video input or output device interface circuitry (e.g., connectors and supporting circuitry) to which a video input device 918 or video output device 908 may be coupled.

The computing device 900 may include a processing device 902 (e.g., one or more processing devices). The processing device 902 processes electronic data from registers and/or memory to transform that electronic data into other electronic data that may be stored in registers and/or memory. The computing device 900 may include a memory 904, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 904 may include memory that shares a die with the processing device 902. In some embodiments, the memory 904 includes one or more non-transitory computer-readable media storing instructions executable for occupancy mapping or collision detection, e.g., the method 700 described above in conjunction with FIG. 7 or some operations performed by any of the systems of FIGS. 1-6, the DNN system 800 in FIG. 8, and/or any other systems discussed herein. The instructions stored in the one or more non-transitory computer-readable media may be executed by the processing device 902.

In some embodiments, the computing device 900 may include a communication chip 912 (e.g., one or more communication chips). For example, the communication chip 912 may be configured for managing wireless communications for the transfer of data to and from the computing device 900. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 912 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 912 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 912 may operate in accordance with other wireless protocols in other embodiments. The computing device 900 may include an antenna 922 to facilitate wireless communications and/or to receive other wireless communications (such as AM or FM radio transmissions).

In some embodiments, the communication chip 912 may manage wired communications, such as electrical, optical, or any other suitable communication protocols (e.g., the Ethernet). As noted above, the communication chip 912 may include multiple communication chips. For instance, a first communication chip 912 may be dedicated to shorter-range wireless communications such as Wi-Fi or Bluetooth, and a second communication chip 912 may be dedicated to longer-range wireless communications such as global positioning system (GPS), EDGE, GPRS, CDMA, WiMAX, LTE, EV-DO, or others. In some embodiments, a first communication chip 912 may be dedicated to wireless communications, and a second communication chip 912 may be dedicated to wired communications.

The computing device 900 may include battery/power circuitry 914. The battery/power circuitry 914 may include one or more energy storage devices (e.g., batteries or capacitors) and/or circuitry for coupling components of the computing device 900 to an energy source separate from the computing device 900 (e.g., AC line power).

The computing device 900 may include a display device 906 (or corresponding interface circuitry, as discussed above). The display device 906 may include any visual indicators, such as a heads-up display, a computer monitor, a projector, a touchscreen display, a liquid crystal display (LCD), a light-emitting diode display, or a flat panel display, for example.

The computing device 900 may include a video output device 908 (or corresponding interface circuitry, as discussed above). The video output device 908 may include any device that generates an audible indicator, such as speakers, headsets, or earbuds, for example.

The computing device 900 may include a video input device 918 (or corresponding interface circuitry, as discussed above). The video input device 918 may include any device that generates a signal representative of a sound, such as microphones, microphone arrays, or digital instruments (e.g., instruments having a musical instrument digital interface (MIDI) output).

The computing device 900 may include a GPS device 916 (or corresponding interface circuitry, as discussed above). The GPS device 916 may be in communication with a satellite-based system and may receive a location of the computing device 900, as known in the art.

The computing device 900 may include another output device 910 (or corresponding interface circuitry, as discussed above). Examples of the other output device 910 may include a video codec, a printer, a wired or wireless transmitter for providing information to other devices, or an additional storage device.

The computing device 900 may include another input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 900 may have any desired form factor, such as a handheld or mobile computer system (e.g., a cell phone, a smartphone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 900 may be any other electronic device that processes data.

### Select Examples

Example 1 provides an apparatus, including a computer processor for executing computer program instructions; and a non-transitory computer-readable memory storing computer program instructions executable by the computer processor to perform operations including receiving an audio input signal including speech from one or more speakers; encoding audio input signal frames at a speech-to-text encoder to generate linguistic token data and acoustic speaker embeddings; identifying the one or more speakers based on the acoustic speaker embeddings; determining, at a context fusion engine, a priority score for each of the one or more speakers; selecting, by a focus selector, a primary speaker based on the priority scores; generating, by an enhancement engine, a spectral emphasis mask based on at least the selected primary speaker and the acoustic speaker embeddings; and applying the spectral emphasis mask to the audio input signal frames to generate enhanced audio that emphasizes the primary speaker.

Example 2 provides the apparatus of example 1, in which determining the priority score includes determining the priority score based on a weighted combination of: acoustic confidence derived from an analysis of the acoustic speaker embeddings, and semantic relevance derived from an analysis of the linguistic token data, role indicators, and keyword significance.

Example 3 provides the apparatus of example 2, further including applying stability control to inhibit rapid switching among the one or more speakers having similar scores, and adaptively updating weights for the weighted combination.

Example 4 provides the apparatus of any one of examples 1-3, in which the encoder performs a single pass for each of the audio input signal frames and concurrently generates the linguistic token data and the acoustic speaker embeddings.

Example 5 provides the apparatus of any one of examples 1-4, in which the acoustic speaker embeddings are time-aligned to the linguistic token data.

Example 6 provides the apparatus of any one of examples 1-5, further including standardizing, by an encoder-agnostic adapter layer, outputs of the speech-to-text encoder by performing at least one of: selecting internal features of the speech-to-text encoder, normalizing values to a canonical range, temporally aligning output rates, and converting encoder-specific data structures into a canonical data format.

Example 7 provides the apparatus of any one of examples 1-6, further including determining semantic features based on the linguistic token data, in which the semantic features include at least one of: content-relevance scoring, vocabulary-domain classification, keyword detection, dialogue role indicators, turn-taking patterns, and conversational continuity measures.

Example 8 provides the apparatus of any one of examples 1-7, in which identifying the one or more speakers includes identifying the one or more speakers without pre-enrollment, and in which identifying the one or more speakers includes performing at least one of: dynamic clustering, similarity computation to evolving speaker profiles, activity detection, and temporal smoothing to maintain speaker continuity.

Example 9 provides the apparatus of any one of examples 1-8, further including a self-calibration loop that monitors the enhanced audio and a transcript produced from the linguistic token data to determine quality indicators.

Example 10 provides the apparatus of example 9, in which the quality indicators include one or more of speaker-switch stability, audio clarity, semantic coherence, content relevance, and artifact presence.

Example 11 provides the apparatus of example 9 or 10, in which the self-calibration loop automatically adjusts parameters for the spectral emphasis mask for subsequent frames.

Example 12 Provides One or More Non-transitory computer-readable media storing instructions executable to perform operations, the operations including receiving an audio input signal including speech from one or more speakers; encoding audio input signal frames at a speech-to-text encoder to generate linguistic token data and acoustic speaker embeddings; identifying the one or more speakers based on the acoustic speaker embeddings; determining, at a context fusion engine, a priority score for each of the one or more speakers; selecting, by a focus selector, a primary speaker based on the priority scores; generating, by an enhancement engine, a spectral emphasis mask based on at least the selected primary speaker and the acoustic speaker embeddings; and applying the spectral emphasis mask to the audio input signal frames to generate enhanced audio that emphasizes the primary speaker.

Example 13 provides the one or more non-transitory computer-readable media of example 12, in which determining the priority score includes determining the priority score based on a weighted combination of: acoustic confidence derived from an analysis of the acoustic speaker embeddings, semantic relevance derived from an analysis of the linguistic token data, role indicators, and keyword significance.

Example 14 provides the one or more non-transitory computer-readable media of example 13, further including applying stability control to inhibit rapid switching among the one or more speakers having similar scores, and adaptively updating weights for the weighted combination.

Example 15 provides the one or more non-transitory computer-readable media of any one of examples 12-14, in which the encoder performs a single pass for each of the audio input signal frames and concurrently generates the linguistic token data and the acoustic speaker embeddings.

Example 16 provides the one or more non-transitory computer-readable media of any one of examples 12-15, in which the acoustic speaker embeddings are time-aligned to the linguistic token data.

Example 17 provides the one or more non-transitory computer-readable media of any one of examples 12-16, further including standardizing, by an encoder-agnostic adapter layer, outputs of the speech-to-text encoder by performing at least one of: selecting internal features of the speech-to-text encoder, normalizing values to a canonical range, temporally aligning output rates, and converting encoder-specific data structures into a canonical data format.

Example 18 provides the one or more non-transitory computer-readable media of any one of examples 12-17, further including determining semantic features based on the linguistic token data, in which the semantic features include at least one of: content-relevance scoring, vocabulary-domain classification, keyword detection, dialogue role indicators, turn-taking patterns, and conversational continuity measures.

Example 19 provides the one or more non-transitory computer-readable media of any one of examples 12-18, in which identifying the one or more speakers includes identifying the one or more speakers without pre-enrollment, and in which identifying the one or more speakers includes performing at least one of: dynamic clustering, similarity computation to evolving speaker profiles, activity detection, and temporal smoothing to maintain speaker continuity.

Example 20 provides the one or more non-transitory computer-readable media of any one of examples 12-19, further including a self-calibration loop that monitors the enhanced audio and a transcript produced from the linguistic token data to determine quality indicators.

Example 21 provides the one or more non-transitory computer-readable media of example 20, in which the quality indicators include one or more of speaker-switch stability, audio clarity, semantic coherence, content relevance, and artifact presence.

Example 22 provides the one or more non-transitory computer-readable media of example 20 or 21, in which the self-calibration loop automatically adjusts parameters for the spectral emphasis mask for subsequent frames.

Example 23 provides a computer-implemented method, including receiving an audio input signal including speech from one or more speakers; encoding audio input signal frames at a speech-to-text encoder to generate linguistic token data and acoustic speaker embeddings; identifying the one or more speakers based on the acoustic speaker embeddings; determining, at a context fusion engine, a priority score for each of the one or more speakers; selecting, by a focus selector, a primary speaker based on the priority scores; generating, by an enhancement engine, a spectral emphasis mask based on at least the selected primary speaker and the acoustic speaker embeddings; and applying the spectral emphasis mask to the audio input signal frames to generate enhanced audio that emphasizes the primary speaker.

Example 24 provides the method of example 23, in which determining the priority score includes determining the priority score based on a weighted combination of: acoustic confidence derived from an analysis of the acoustic speaker embeddings, semantic relevance derived from an analysis of the linguistic token data, role indicators, and keyword significance.

Example 25 provides the method of example 24, further including applying stability control to inhibit rapid switching among the one or more speakers having similar scores, and adaptively updating weights for the weighted combination.

Example 26 provides the method of any one of examples 23-25, in which the encoder performs a single pass for each of the audio input signal frames and concurrently generates the linguistic token data and the acoustic speaker embeddings.

Example 27 provides the method of any one of examples 23-26, in which the acoustic speaker embeddings are time-aligned to the linguistic token data.

Example 28 provides the method of any one of examples 23-27, further including standardizing, by an encoder-agnostic adapter layer, outputs of the speech-to-text encoder by performing at least one of: selecting internal features of the speech-to-text encoder, normalizing values to a canonical range, temporally aligning output rates, and converting encoder-specific data structures into a canonical data format.

Example 29 provides the method of any one of examples 23-28, further including determining semantic features based on the linguistic token data, in which the semantic features include at least one of: content-relevance scoring, vocabulary-domain classification, keyword detection, dialogue role indicators, turn-taking patterns, and conversational continuity measures.

Example 30 provides the method of any one of examples 23-29, in which identifying the one or more speakers includes identifying the one or more speakers without pre-enrollment, and in which identifying the one or more speakers includes performing at least one of: dynamic clustering, similarity computation to evolving speaker profiles, activity detection, and temporal smoothing to maintain speaker continuity.

Example 31 provides the method of any one of examples 23-30, further including a self-calibration loop that monitors the enhanced audio and a transcript produced from the linguistic token data to determine quality indicators.

Example 32 provides the method of example 31, in which the quality indicators include one or more of speaker-switch stability, audio clarity, semantic coherence, content relevance, and artifact presence.

Example 33 provides the method of example 31 or 32, in which the self-calibration loop automatically adjusts parameters for the spectral emphasis mask for subsequent frames.

Example 35 provides the apparatus of example 2 and/or the one or more non-transitory computer-readable media of example 13 and/or the method of example 24, wherein semantic relevance includes one or more of: content relevance, domain, keywords, roles, and continuity.

Example 35 provides the apparatus of example 2 and/or the one or more non-transitory computer-readable media of example 13 and/or the method of example 24, further comprising determining semantic features based on the linguistic token data, wherein the semantic features include at least one of: content relevance scoring, vocabulary domain classification, keyword detection, dialogue role indicators, turn taking patterns, and conversational continuity measures, and wherein the semantic relevance is based on the semantic features.

Example 36 provides the apparatus of example 11 and/or the one or more non-transitory computer-readable media of example 22 and/or the method of example 33, wherein the parameters include one or more of fusion weights and enhancement mask parameters.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

What is claimed is:

1. An apparatus, comprising:
a computer processor for executing computer program instructions; and
a non-transitory computer-readable memory storing computer program instructions executable by the computer processor to perform operations comprising:
receiving an audio input signal including speech from one or more speakers;
encoding audio input signal frames at a speech-to-text encoder to generate linguistic token data and acoustic speaker embeddings;
identifying the one or more speakers based on the acoustic speaker embeddings;
determining, at a context fusion engine, a priority score for each of the one or more speakers;
selecting, by a focus selector, a primary speaker based on the priority scores;
generating, by an enhancement engine, a spectral emphasis mask based on at least the selected primary speaker and the acoustic speaker embeddings; and
applying the spectral emphasis mask to the audio input signal frames to generate enhanced audio that emphasizes the primary speaker.

2. The apparatus of claim 1, wherein determining the priority score includes determining the priority score based on a weighted combination of: acoustic confidence derived from an analysis of the acoustic speaker embeddings, semantic relevance derived from an analysis of the linguistic token data, role indicators, and keyword significance.

3. The apparatus of claim 2, further comprising applying stability control to inhibit rapid switching among the one or more speakers having similar scores, and adaptively updating weights for the weighted combination.

4. The apparatus of claim 1, wherein the encoder performs a single pass for each of the audio input signal frames and concurrently generates the linguistic token data and the acoustic speaker embeddings.

5. The apparatus of claim 1, wherein the acoustic speaker embeddings are time-aligned to the linguistic token data.

6. The apparatus of claim 1, further comprising standardizing, by an encoder-agnostic adapter layer, outputs of the speech-to-text encoder by performing at least one of: selecting internal features of the speech-to-text encoder, normalizing values to a canonical range, temporally aligning output rates, and converting encoder-specific data structures into a canonical data format.

7. The apparatus of claim 1, further comprising determining semantic features based on the linguistic token data, wherein the semantic features include at least one of: content-relevance scoring, vocabulary-domain classification, keyword detection, dialogue role indicators, turn-taking patterns, and conversational continuity measures.

8. The apparatus of claim 1, wherein identifying the one or more speakers includes identifying the one or more speakers without pre-enrollment, and wherein identifying the one or more speakers includes performing at least one of: dynamic clustering, similarity computation to evolving speaker profiles, activity detection, and temporal smoothing to maintain speaker continuity.

9. The apparatus of claim 1, further comprising a self-calibration loop that monitors the enhanced audio and a transcript produced from the linguistic token data to determine quality indicators.

10. The apparatus of claim 9, wherein the quality indicators include one or more of speaker-switch stability, audio clarity, semantic coherence, content relevance, and artifact presence.

11. The apparatus of claim 9, wherein the self-calibration loop automatically adjusts parameters for the spectral emphasis mask for subsequent frames.

12. One or more non-transitory computer-readable media storing instructions executable to perform operations, the operations comprising:
receiving an audio input signal including speech from one or more speakers;
encoding audio input signal frames at a speech-to-text encoder to generate linguistic token data and acoustic speaker embeddings;
identifying the one or more speakers based on the acoustic speaker embeddings;
determining, at a context fusion engine, a priority score for each of the one or more speakers;
selecting, by a focus selector, a primary speaker based on the priority scores;
generating, by an enhancement engine, a spectral emphasis mask based on at least the selected primary speaker and the acoustic speaker embeddings; and
applying the spectral emphasis mask to the audio input signal frames to generate enhanced audio that emphasizes the primary speaker.

13. The one or more non-transitory computer-readable media of claim 12, wherein determining the priority score includes determining the priority score based on a weighted combination of: acoustic confidence derived from an analysis of the acoustic speaker embeddings, semantic relevance derived from an analysis of the linguistic token data, role indicators, and keyword significance.

14. The one or more non-transitory computer-readable media of claim 13, further comprising applying stability control to inhibit rapid switching among the one or more speakers having similar scores, and adaptively updating weights for the weighted combination.

15. The one or more non-transitory computer-readable media of claim 12, wherein the encoder performs a single pass for each of the audio input signal frames and concurrently generates the linguistic token data and the acoustic speaker embeddings.

16. The one or more non-transitory computer-readable media of claim 12, wherein the acoustic speaker embeddings are time-aligned to the linguistic token data.

17. The one or more non-transitory computer-readable media of claim 12, further comprising standardizing, by an encoder-agnostic adapter layer, outputs of the speech-to-text encoder by performing at least one of: selecting internal features of the speech-to-text encoder, normalizing values to a canonical range, temporally aligning output rates, and converting encoder-specific data structures into a canonical data format.

18. The one or more non-transitory computer-readable media of claim 12, further comprising determining semantic features based on the linguistic token data, wherein the semantic features include at least one of: content-relevance scoring, vocabulary-domain classification, keyword detection, dialogue role indicators, turn-taking patterns, and conversational continuity measures.

19. The one or more non-transitory computer-readable media of claim 12, wherein identifying the one or more speakers includes identifying the one or more speakers without pre-enrollment, and wherein identifying the one or more speakers includes performing at least one of: dynamic clustering, similarity computation to evolving speaker profiles, activity detection, and temporal smoothing to maintain speaker continuity.

20. A computer-implemented method, comprising:
receiving an audio input signal including speech from one or more speakers;
encoding audio input signal frames at a speech-to-text encoder to generate linguistic token data and acoustic speaker embeddings;
identifying the one or more speakers based on the acoustic speaker embeddings;
determining, at a context fusion engine, a priority score for each of the one or more speakers;
selecting, by a focus selector, a primary speaker based on the priority scores;
generating, by an enhancement engine, a spectral emphasis mask based on at least the selected primary speaker and the acoustic speaker embeddings; and
applying the spectral emphasis mask to the audio input signal frames to generate enhanced audio that emphasizes the primary speaker.
